(19) United States
(12) Patent Application Publication
(10) Pub. No.: US 2008/0101718 A1
(43) Pub. Date: May 1, 2008

(54) Apparatus and method for deblock filtering

(75) Inventors: Kuo-Uei Yang, Taipei City (TW); Ching-Feng Huang, Tainan City (TW)

Correspondence Address: BIRCH STEWART KOLASCH & BIRCH, PO BOX 747, FALLS CHURCH, VA, 22040-0747, US

(73) Assignee: Realtek Semiconductor Corp.

(21) Appl. No.: 11/976,282

(22) Filed: Oct. 23, 2007

(30) Foreign Application Priority Data
Oct. 25, 2006 (TW) 095139287

(51) Int. Cl. G06K 9/40

(52) U.S. Cl. 382/268

(57) ABSTRACT

A method of processing a frame including a plurality of macro-blocks is provided. Each of the macro-blocks respectively includes M pixels. A local buffer is previously provided. The capacity of the local buffer is equal to the size of N pixels. M and N are both positive integers. N is smaller than or equal to M. A target area is first selected from the micro-blocks, and then N pixels within the target area are stored in the local buffer. Afterward, the method performs a deblock filtering procedure on the N pixels stored in the local buffer.

### BACKGROUND OF THE INVENTION

1. Field of the Invention

The invention relates to a method and an apparatus of image processing, and more particularly, to a method and an apparatus of eliminating block effects of an image.

2. Description of the Prior Art

For many present standards of the image compression, discrete cosine transform (DCT) is a frequently used method of code-transformation. In general, before DCT is performed on a video frame, the video frame will be first divided into blocks, and each of the blocks includes 8*8 pixels. Moreover, DCT is performed on each of the blocks. In order to meet the restrictions of related hardware or internet bandwidth, DCT and subsequent coding procedures remove high-frequency features along with parts of correlation among adjacent blocks. Consequently, the so-called block effects are induced. The images with obvious block effects induce rough color or brightness boundaries among blocks, thus reducing the quality of images.

Referring to FIG. 1, FIG. 1 is a schematic diagram of a video frame 10. The video frame 10 is formed by blocks 11. The horizontal boundaries 12A and vertical boundaries 12B among blocks 11 are the places where block effects may be generated.

In order to solve the problems caused by the block effect, several methods were used. Taking the application in MPEG4 for example, all pixels within the video frame 10 are first stored in a buffer whose capacity equals the size of the video frame 10. Afterwards, based on the pixels stored in the buffer, deblock filtering of all horizontal boundaries 12A, and then of all vertical boundaries 12B are performed to eliminate the block effect.

Because the capacity of the buffer used conventionally has to be equal to the size of an entire video frame, the bigger the size of a video frame is, the capacity of the buffer is increased correspondingly. Hence, an increase in the cost of required hardware is foreseeable.

### SUMMARY OF THE INVENTION

The invention provides a method and an apparatus for eliminating block effects of image. According to the invention, a frame is divided into a plurality of micro-blocks, and a micro-block is the basic unit of performing deblock filtering. The capacity of a buffer may be smaller than or equal to the size of a micro-block based on the invention.

The invention assumes that each of the macro-blocks includes M pixels, and M is a positive integer. A local buffer is provided.

In a preferred embodiment of an image-adjusting method, a target area is first selected from the micro-blocks within the frame, and N pixels within the target area are stored in the local buffer, wherein N is a positive integer smaller than or equal to M. Afterwards, the method performs deblock filtering on the N pixels stored in the local buffer.

Another preferred embodiment of the invention is an image adjusting apparatus. The image-adjusting apparatus includes a storing module and a filtering module besides the local buffer. The storing module is used to select a target area within the frame, and to store N pixels of the target area in the local buffer. The filtering module performs deblock filtering on the N pixels stored in the local buffer.

The method and the apparatus according to the invention can be used in the standards of image compression which adopts a block as the basic unit of coding and decoding; for examples, MPEG4, JPEG, and H.263.

The advantage and spirit of the invention may be understood by the following recitations together with the appended drawings.

### BRIEF DESCRIPTION OF THE APPENDED DRAWINGS

FIG. 1 is a schematic diagram of a video frame.

FIG. 2A is a schematic diagram of a micro-block.

FIG. 2B and FIG. 2C are schematic diagrams of a rectangle formed in the target area by N pixels stored in the local buffer.

FIG. 2D is a schematic diagram of a wedge formed in the target area by N pixels stored in the local buffer.

FIG. 3A is a schematic diagram of the neighboring blocks repeating as the wedge area shown in FIG. 3B is a schematic diagram of the neighboring blocks repeating as the wedge area shown in FIG. 2D along the horizontal direction.

FIG. 4 is a flow chart of a preferred embodiment of the image processing method according to the invention.

FIG. 5 is a schematic diagram of a preferred embodiment of the image processing apparatus according to the invention.

FIG. 6 and FIG. 7 are schematic diagrams of an example of filtering module containing eight parallel process elements.

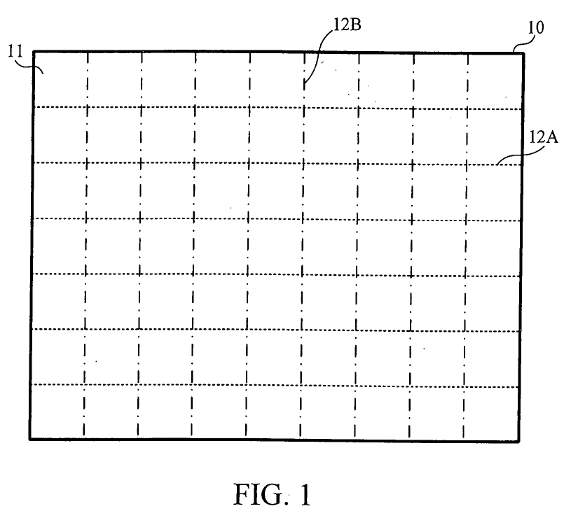

### DETAILED DESCRIPTION OF THE INVENTION

The invention provides a method and an apparatus for eliminating block effects of images. In the method and apparatus, a frame is divided into micro-blocks. Taking the MPEG4 standard as an example, the micro-block can include six blocks, in which four blocks can be interpreted as Y, while the other two blocks can be Cb and Cr respectively.

A micro-block is the basic unit of performing deblock filtering. Taking the MPEG4 standard as an example, the above-mentioned Y, Cb, and Cr are the so-called block types. Because many standards of image processing are known by those skilled in the art, the number and type which may be included in a micro-block of the invention are not further described herein.

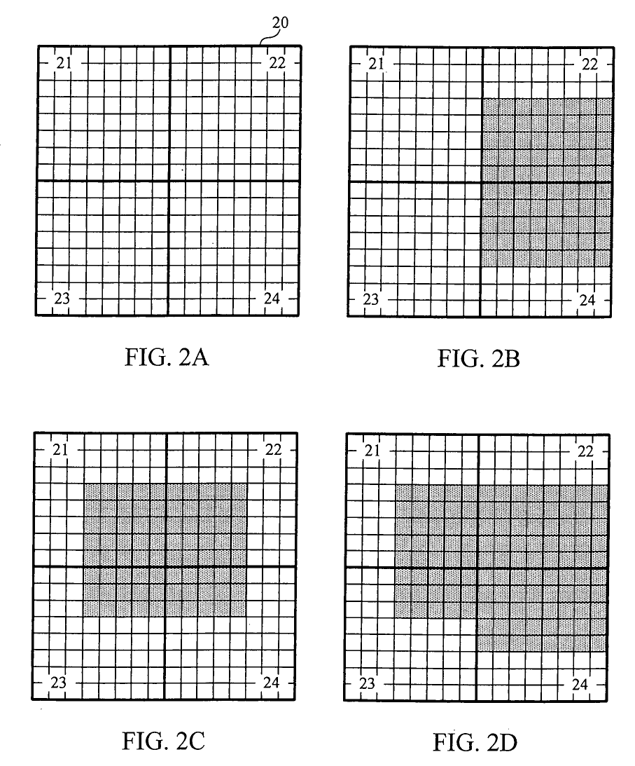

The invention assumes that each of the macro-blocks includes M pixels, and M is a positive integer. The following example is that each of micro-blocks includes four blocks. If each of the blocks includes 8*8 pixels, then M equals 4*8*8. That is to say, each of the micro-blocks includes 256 pixels to be processed. Referring to FIG. 2A, FIG. 2A is a schematic diagram of a micro-block 20. The micro-block 20 includes four blocks 21, 22, 23, and 24. As shown in FIG. 2A, each of the blocks includes 8*8 pixels.

A local buffer is provided beforehand. And the capacity of the local buffer can be equal to the size of a memory for storing N pixels, wherein N is a positive integer smaller than or equal to M. In practical applications, the local buffer can be a randomly accessible register or a wide-bus memory. The specification of the local buffer can be designed based on practical requirements and should not be limited to the two/types mentioned above.

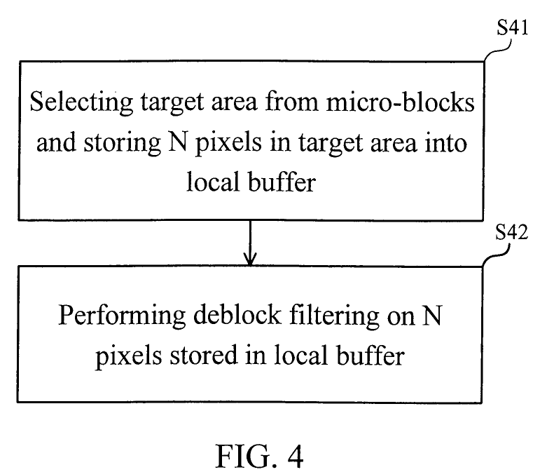

FIG. 4 is a flow chart of a preferred embodiment of the image processing method. Referring to FIG. 4, in the image processing method, step S41 is first performed to select a large region including parts of the micro-blocks as a target area. Then, N pixels within the target area are stored in the local buffer. Afterwards, step S42 is triggered to perform deblock filtering on the N pixels stored in the local buffer.

According to different image processing standards, the procedure of deblock filtering in step S42 may be different. Taking the MPEG4 standard as an example, step S42 can further include sub-steps of filtering mode decision, DC offset mode filtering, and default mode filtering. The above-mentioned sub-steps are only the examples applied in the MPEG4 standard, as they are not used to restrict the scope of the invention.

In practical applications, the N pixels stored in the local buffer, shown as the dark part in FIG. 2B or FIG. 2C, may form a rectangle in the target area or form a wedge, as shown in the dark part of FIG. 2D. The process of selecting the N pixels is quite flexible, which is adjustable based on the practical needs. In the example shown in FIG. 2B, the rectangular area formed by the N pixels covers the horizontal boundaries between block 22 and block 24. Thus, the deblock filtering performed on the N pixels is to eliminate block effects between block 22 and block 24.

In the example shown in FIG. 2C, the rectangular area formed by the N pixels covers partial vertical boundaries between block 21 and block 22, and between block 23 and block 24. Thus, the deblock filtering performed on the N pixels is to eliminate block effects between the above-mentioned blocks.

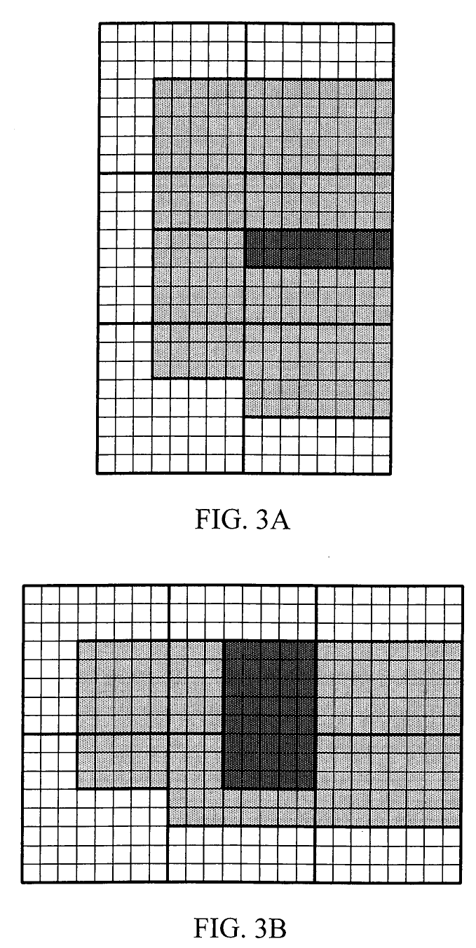

In general, step S41 and step S42 will be repeated in the image processing method until all micro-blocks in the video frame have been performed with the deblock filtering. In this way, the block effects of the entire frame can be eliminated. Referring to FIGS. 3A and 3B, FIG. 3A is a schematic diagram of repeating the wedge area shown in FIG. 2D along the vertical direction; FIG. 3B is a schematic diagram of repeating the wedge area shown in FIG. 2D along the horizontal direction.

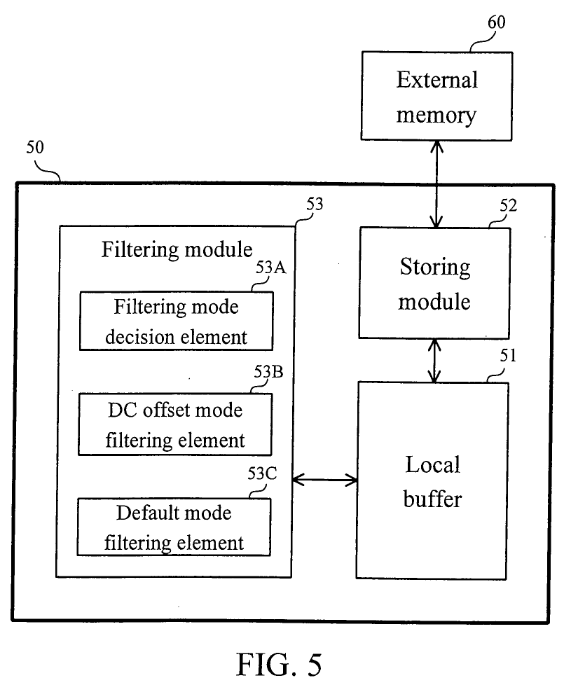

FIG. 5 shows a preferred embodiment of the image processing apparatus. Referring to FIG. 5, except the local buffer 51, the image adjusting apparatus 50 includes a storing module 52 and a filtering module 53. The on-processing video frame is generally stored in an external memory 60 outside the image adjusting apparatus 50. The storing module 52 is connected to the memory 60 and is used to select a region including parts of the micro-blocks as a target area. Then, N pixels of the target area are stored in the local buffer 51. The filtering module 53 is used to perform deblock filtering on the N pixels stored in the local buffer 51. After being processed by the filtering module 53, the N pixels may be rewritten into the local buffer 51.

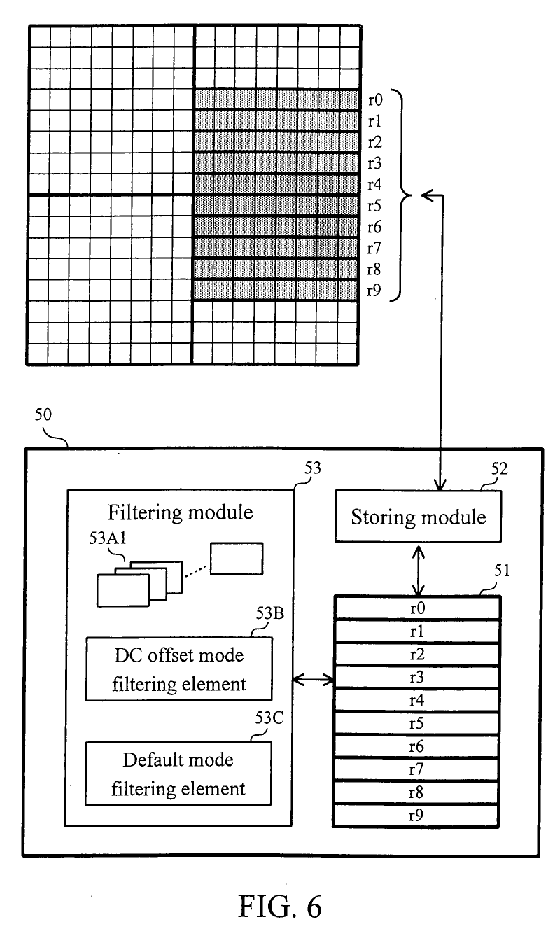

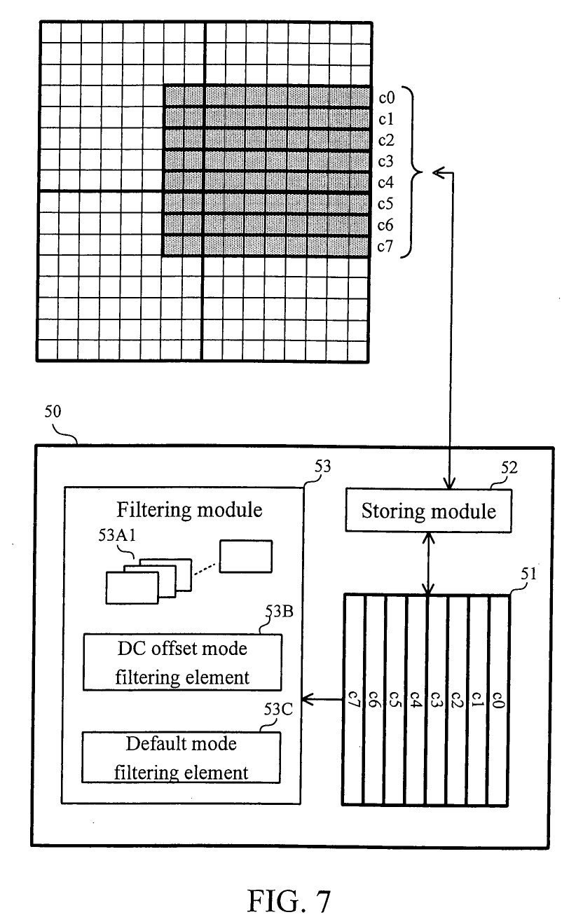

According to different image processing standards, the procedure of deblock filtering in the filtering module 53 may be different. Taking the MPEG4 as an example, the filtering module 53 is likely shown as FIG. 5 which includes a filtering mode decision element 53A, a DC offset mode filtering element 53B, and a default mode filtering element 53C. The embodiment is only an example of the MPEG4 standard, and is not used as a restriction to the scope of the invention. The capacity of the local buffer 51 depends on the number of pixels in the target area. For example, if a block includes 8*8 pixels, the capacity of local buffer 51 could be equal to the size of 8*10, 8*5, or even 8*1 pixels. In practical applications, the filtering mode decision element 53A in the filtering module 53 is able to use two or more parallel process elements. A local buffer 51 containing 8*10 pixels is taken as an example. Referring FIG. 6 and FIG. 7, FIG. 6 and FIG. 7 show an example of a filtering module 53 containing eight parallel process elements 53A1.

In the example shown in FIG. 6, the storing module 52 first loads ten pixel areas r0˜r9 into local buffer 51. Each of the pixel areas includes 8*1 pixels. Afterwards, the 8 parallel process elements 53A1, the DC offset mode filtering element 53B, and the default mode filtering element 53C in the filtering module 53 are used to perform deblock filtering on the horizontal boundaries of the 80 pixels.

In the example shown in FIG. 7, the storing module 52 first loads eight pixel areas c0˜c7 into local buffer 51. Each of the pixel areas includes 10*1 pixels. Afterwards, the 8 parallel process elements 53A1, the DC offset mode filtering element 53B, and the default mode filtering element 53C in the filtering module 53 are used to perform deblock filtering on the vertical boundaries of the 80 pixels. In practical applications, the local buffer 51 in FIG. 7 can include a rotation element (not shown in the figure) for rotating the pixel areas c0˜C7 which are set perpendicularly to the local buffer 51, and store them in the local buffer 51 to fit the memory configuration of the local buffer 51.

In the invention, the process of eliminating block effects of horizontal boundaries and vertical boundaries can be performed with pipeline processing, instead of processing horizontal boundaries before vertical boundaries (or in an opposite order). Thus, the required capacity of the buffer memory is fairly decreased. The above-mentioned pipeline processing, and the operations performed by the filtering mode decision element 53A, the DC offset mode filtering element 53B, and the default mode filtering 53C should be known by those skilled in the art, so the details are omitted here for brevity.

The image processing apparatus 50 can further include a repeating module (not shown in the figure) to repeatedly control the storing module 52 and the filtering module 53, until all micro-blocks in the frame have been performed with deblock filtering.

As described above, the method and apparatus according to the invention can be used in image compression standards whose basic element of coding and decoding is a block, such as MPEG4, JPEG, and H.263. And, the capacity of the buffer based on the invention only needs to be smaller than or equal to the size of a micro-block. Compared to the buffer with a capacity of thousands of pixels used conventionally, a cheaper and smaller buffer can be used in the invention.

With the above example and explanation, the features and spirits of the invention will be hopefully well described. Those skilled in the art will readily observe that numerous modifications and alterations of the apparatus may be made while retaining the teaching of the invention. Accordingly, the above disclosure should be construed as limited only by the metes and bounds of the appended claims.

What is claimed is:

1. A method for eliminating block effects of a frame, the frame comprising a plurality of macro-blocks, each of the macro-blocks comprising M pixels, M being a positive integer and a local buffer being provided, said method comprising the steps of:
(a) selecting a target area in the frame;
(b) storing N pixels of the target area into the local buffer, N being a positive integer smaller than or equal to M;
(c) deblock filtering the N pixels stored in the local buffer; and
(d) repeating step (a), step (b), and step (c).

2. The method of claim 1, said method further comprising the step of:
repeating step (d) until deblock filtering all the macro-blocks in the frame.

3. The method of claim 1, wherein the capacity of the local buffer equals the size of 8*k pixels, and k is a positive integer.

4. The method of claim 1, wherein the local buffer is a randomly accessible register or a wide-bus memory.

5. The method of claim 1, wherein the local buffer comprises a rotation element, if the configuration of the N pixels is perpendicular to the local buffer, the rotation element is used to rotate the N pixels and store them in the local buffer.

6. The method of claim 1, wherein the N pixels stored in the local buffer form a rectangle or a wedge within the target area.

7. The method of claim 1, wherein the deblock filtering comprises filtering mode decision, DC offset mode filtering, default mode filtering, or combinations thereof.

8. The method of claim 1, wherein the deblock filtering is performed on at least one horizontal boundary and at least one vertical boundary of the target area with pipeline processing.

9. The method of claim 1, wherein each of the macro-blocks comprises k*k blocks, k being a positive integer, and each of the k*k blocks comprises 8*8 pixels.

10. The method of claim 1, wherein the method is applicable to an image compression standard using a block as a basic coding/decoding unit.

11. An apparatus for eliminating block effects of a frame, the frame comprising a plurality of macro-blocks, each of the macro-blocks comprising M pixels, M being a positive number, said apparatus comprising:
a storing module for selecting a target area in the frame;
a local buffer for storing N pixels in the target area, N being a positive integer smaller than or equal to M; and
a filtering module for deblock filtering the N pixels stored in the local buffer.

12. The apparatus of claim 11, said apparatus further comprising:
a repeating module for repeatedly operating the storing module and the filtering module until deblock filtering all the macro-blocks in the frame.

13. The apparatus of claim 11, wherein the capacity of the local buffer equals the size of 8*k pixels, and k is a positive integer.

14. The apparatus of claim 11, wherein the local buffer is a randomly accessible register or a wide-bus memory.

15. The apparatus of claim 11, wherein the local buffer comprises a rotation element, if the configuration of the N pixels is perpendicular to the local buffer, the rotation element is used to rotate the N pixels and store them in the local buffer.

16. The apparatus of claim 11, wherein the N pixels stored in the local buffer form a rectangle or a wedge within the target area.

17. The apparatus of claim 11, wherein the filtering module further comprises at least one of the following elements: a filtering mode decision element, a DC offset mode filtering element, and a default mode filtering element.

18. The apparatus of claim 11, wherein in the filtering module, the deblock filtering is performed on at least one horizontal boundary and at least one vertical boundary of the target area with pipeline process.

19. The apparatus of claim 11, wherein each of the macro-blocks comprises k*k blocks, k being a positive integer, and each of the k*k blocks comprises 8*8 pixels.

20. The apparatus of claim 11, wherein the apparatus is applicable to an image compression standard using a block as a basic coding/decoding unit.
